(19) United States
(12) Patent Application Publication
(10) Pub. No.: US 2021/0363647 A1
(43) Pub. Date: Nov. 25, 2021

(54) DEVICE FOR PRODUCING ENERGY FROM WATER MOLECULES

(71) Applicant: Dhuhi Al-Barwani, Muscat (OM)

(72) Inventor: Dhuhi Al-Barwani, Muscat (OM)

(21) Appl. No.: 16/978,716

(22) PCT Filed: Jul. 24, 2018
(86) PCT No.: PCT/OM2018/050009

§ 371 Date: Sep. 7, 2020

(30) Foreign Application Priority Data
Mar. 8, 2018 (OM) OM/P/2018/00061

(51) Int. Cl. C25B 1/04; C25B 15/02; C25B 9/17; C25B 15/08

(52) U.S. Cl. CPC C25B 1/04; C25B 15/08; C25B 9/17; C25B 15/02

(57) ABSTRACT

The invention is transforming water molecules into gas flames; the new invention is an electrical machine system that produce from water which consist hydrogen and oxygen gases the modulates the gas and air mixture as per required burning rate with high efficiency that can be utilized such as in heating, cutting materials, welding formation, burner, powering motors, assisting power plant, cooking, etc. where its clean energy and safe to environment, economical and user friendly.

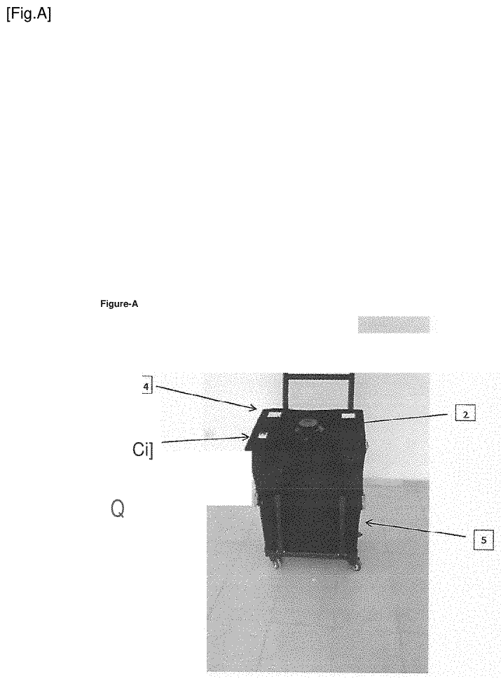

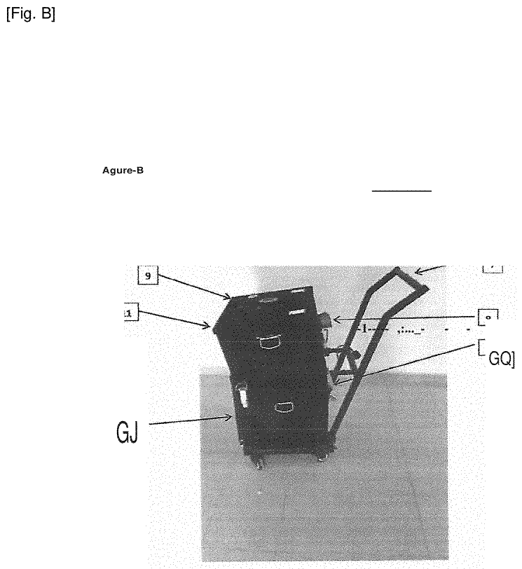

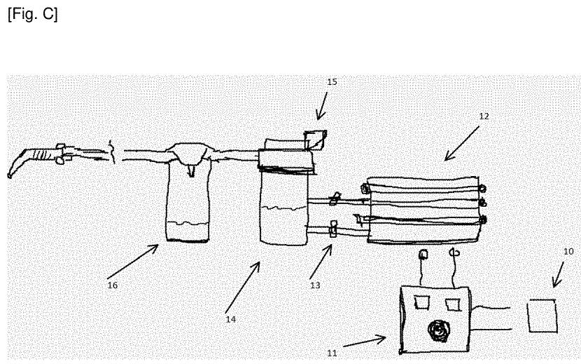

### TECHNICAL FIELD

The present disclosure relates generally to the water source of energy that consists of hydrogen and oxygen to be applied. Certain embodiments relates more specifically to devices, systems, methods for empowering and thermal energy utilization.

### BACKGROUND ART

Water gas technology it's a clean energy gas that is derived from hydrogen and oxygen (H2O) it has no side effect to the environment, free from toxic and a clean energy source. Its portable water gas machine that produce gas on demand with efficiency without the need of storage gas and which applied adequate burning flame.

There are many apparatus and products in the market that produce from carbonate gases such as (Butane gas, LPG propane, Acetylene gas, etc.) that stored in compressed tank. However there is no single apparatus or product in market currently can produce multipurpose application that can be used for wide range of fields at same time use such as to for (burner for heating, cutting, welding formation, cooking etc.) It requires a proper burning rate for each application that can be addressed form low B.T.U to High B.T.U for example that require temperature from 100 c to 3000 c more or less as per desired range. In addition to that the traditional apparatus has to be kept at isolated and restrictive area, need proper shipment procedure, logistics, require lots of attention on health hazard may poses great on toxicity level and also endanger of explosion.

This entire obstacle is a numerous cost implication and plus insurance premium increase over time. In especially now we are facing challenges in economic changes, shortage of energy, global warming warnings and pollution on sea, air and soil. Demand of cleaner and sustainable renewable energy is be highly required for obvious reason motioned to better sustained and succeed in our economy and for cleaner environment. Other type of gas producer from hydrolysis apparatus such as from coal to gasification process it's hard to control and managed. Due to its limitation its only can be on operated out door. Next other mentioned method is employed by conventional chemical solution and electrolysis for gases dissociation due to the obstacles is cost operation, high power consumption and expensive equipment required. Some other type of electrical cooker consumes high electrical bills where present invention is economical electrical usage. The conventional units or systems addressed the may be applicable in certain condition but will not be suitable at present invention as described.

### SUMMARY OF INVENTION

A primary of present invention is a multiple purpose portable water gas machine that can be applied for such as heating, cutting all type of materials, welding formation, molding, powering motors, power plant enhancement, burner and cooking. etc.

Another object is provide reduced or low electrical input to obtain from water energy splitting into hydrogen and oxygen in efficient way and economical set up.

A still further object is to modulate the proper gas mixture and ambient ratio where is to bring to applicable burning rate to desired application in chosen adequate set up such for burner heating mode, cutting materials, welding formation temperature and cooking temperature ratio set.

Other object of invention is controlled by electrical power input, electronic apparatus and Ac varic transformer regulate electrical voltage and frequency to the H2O exciters chamber and harmonized accordingly.

Another object of present invention is use ordinary water or distilled water to the reactor or exciters chamber after being conditioned and properly charged to release or emanate hydrogen and oxygen gases that will form on demand, without having the need of storage pressured tank as the traditional way is been utilized gas purpose such as in welding oxy acetylene gas, burner gas for heating or cooking, etc.

Other present invention of portable water gas machine is easiness of transportation or mobility. It can be carried or shipped by one person or operator by any time and condition even it can operate in confined space room without endangering with toxic gases suffocation and risk of explosion. It's featured sub assembly designed with quick release disassembly and assembly as full unit at reasonable time and convenient. Where is other conventional units are heavy bulky, unsafe, requires special space storage area with restricted premises, that may poses leakage gas, that can lead to explosion and fire. While water gas machine require no compressed gas storage and can be maintained cheaply and can be kept indoor safely without concern of leakage gas or fire explosion. Its clean gas, other merit of gas it dissipates quickly into air safely without toxic gas.

In addition embodiment water gas machine splitting water into hydrogen and oxygen by using LC circuit method what is known in the art. In tuning to propagate water molecules to reach high energy level, the LC circuit mode is employed from AC induction to convert ripple pulse from mode controller to the exciters chamber. It's contrary from conventional subjugation on employment by hydrolysis/or electrolysis and chemical solution of addressment or direction with applied firm electrical DC that what captivated in electrodes polarity for gas segregation. The prior art requires a lot of electrical power consumption, heat lose and fluid dissipation.

Still another feature of present invention resides in the machine system have a safety circuit breaker switch intermittent of any electrical faulty or abnormal at electrical flow from in integrated system.

Yet another embodiment have a build in safety mechanism in case of back fire, is to implode back into water tank and release access pressure by relieve valve or solenoid valve pressure sensor to the safely ambient air.

In addition to the present invention electromagnetic pipe anti-corrosion employed for induction to the LC circuit pick up pulse to further propagates the gas flow exit port. In inducing water circulation current and electrical pulses flow to the exciters chamber to bring better equilibrium water state.

The feature of the present invention the gas pressure psi maintained and monitored through pressure gauge screen and with electrical parameters display controlled by operating device.

### Technical Problem

The current machine is expensive, produces high electrical power consumption, cannot be used in many applications but can be applied in limited one approach due to fixed setting on burning rate and not environment friendly and susceptible for explosion.

### Solution to Problem

Water gas technology is type of clean gas energy what comes from hydrogen and oxygen (H2O) which doesn't have negative side effect to environment, free from toxic gases and its clean source of energy. This machine carries water and it produces gas on demand with high efficiency without the need of storing gas, which produces a sustainable flammable for burning

### BRIEF DESCRIPTION OF DRAWINGS

To illustrate understanding, reference will be to herein below describe FIGURE in which represents the following:

FIG-A Is the front prospective view of portable water gas machine.

FIG-B Is the side view showing of the water gas machine in angle prospective.

FIG-c Is the drawing showing the structural interconnection of components or constituents

### Drawing A

1: Power unit machine
2: Control device
3: Electrical switch
4: gauge meters
5: Reactor or Exciters

### Drawing B

6: Reactor on side view
7: Transporter for machine
8: Electrical connectors
9: Circuit breaker
10: Electrical connector from power unit

### Drawing C

11: Power unit machine controller
12: Reactor
13: check valve and water flow tubing
14: water filter
15: gas pressure relieve
16: gas filter

### DESCRIPTION OF EMBODIMENTS

With reference to the views and drawings in accordance to present invention is illustrated as shown in FIGURE-A

The portable water gas machine 1 is divided into part body segment in divisible one unite interconnected by latches, that can be quick dissemble and assemble design that can take one person/operator to install. It consists of several components and section, the top division 2 is a electrical controller varic—transformer that coming from AC source supply. Then thereafter is energized water cavity in the reactor chamber 5 in the bottom division through the excitation to generate water molecules made by LC circuit to oscillate with greater amplitude to release hydrogen and oxygen gases. While also controls the electrical parameters and indication 4 it also controls water gas flow rate. The electrical controller unit 2 has built in safety feature shut off switch 3 a circuit breaker in case of electrical faulty. There is a option apparatus component a gas modulator 5 is not shown extracted from ambient air, for the purpose of reducing or regulating high burning ratting gas and proper gas mixture composition as per requirement at desired application to be applied with. Where the display meters 4 guides the operator to set and monitor the power operation and the condition of the units or machine status.

With reference side view to the FIGURE-B

Towards the side of portable water gas machine as shown 7 its transportable or mobile with the machine units attachment laches 6 fixed and released during assembly 10 at rear. It has electrical cord with water proof build in connection for power source interconnected for both 8 units sub section electrical wire connection 11 and 6. The bottom part section 6 unit where is contain water storage tank and refiller. It has water circulation flow system with rebreather equalizer to reactor chamber into filtration process to discard from water container then next to gas collector chamber to output port gas exit. That will be illustrated further to description at FIGURE-c with schematic process view section.

With cross reference inside with schematic prospective view FIGURE-c

The components consists with power source 10 AC 240v that reduced or varied to converter control unit 11 that ranges to produce gas production from 70 volts to 150 volts and 2 to 8 amps. Plus with a parameter gauge reading display which circuit breaker. The exciter or reactor unit that produces water gases when its charges 12 when it balances or harmonizes established with converted unit 11. The gases passes though sealed water filter 14 as shown through tubes and circulated water 13 which keeps the under normal water temperature. Over gas pressure relieve valve 15 and back pressure protection. There other Filter container 16 separates water moist and gases to the channel tube hose that carry hydrogen and oxygen gases the end use to the burner or torch. Two Electromagnetic connected pipe anti-corrosion 13 for induction to LC circuit 11 pulse to further propagate the gas flow toward upper pipe exit port.

### EXAMPLES

[symbol]

### Industrial Applicability

[symbol]

### REFERENCE SIGNS LIST

[symbol]

### REFERENCE TO DEPOSITED BIOLOGICAL MATERIAL

[symbol]

### SEQUENCE LISTING FREE TEXT

[symbol]

### CITATION LIST

[symbol]

### Patent Literature

PTL1:

### Non Patent Literature

NPL1:

1. The machine produces power from water molecules through transforming into flame by electrical unit to generate gases hydrogen and oxygen from water and mixture with ambient air to give proper burning rating in addition to high efficiency. It consist of machine water container, reactor, electrical unit control, electrical connection sockets, water and gas plumping flow, parameter gauges, filtration system and key switch.

2. Machine produce energy gas as set forth claim 1, power ranges output unit is 70 volts to 110 volts and 2 to 8 amps.

3. The machine produce energy as set forth claim 1, from reactor or exciter unit uses normal water or distill water after is been conditioned from charged to produce hydrogen and oxygen gas simultaneously on demand.

4. Machine produce energy as set forth claim 1, as multiple purpose portable water gas machine that can be applied for such as heating appliances, cutting all type of martials, welding formation, molding, powering motors, power plant enhancement, burner and cooking. etc.

5. Machine produce energy as set forth claim 1; water gas device provides low electrical power wattage from 200 to 500 w proximity range input operating. Output gas form 3.5 L to 6 L pm.

6. Machine produce energy as set forth claim 1, water gas machine apparatus it can modulate the adequate gas mixture with ambient air where can bring to applicable burning rate to desired application that ranges from 100 c to 3000c from above or less B.T.U.

7. Machine produce energy set forth claim 1, water gas machine it operate an controlled with low electrical input, electronic apparatus LC mode circuit and AC varic transformer to regulate electrical voltage and frequency to the H2O exciters chamber and harmonized accordingly.

8. The machine produce energy set forth claim 1, water gas machine use ordinary water or distilled water to reactor or exciters chamber after being conditioned aqua and properly charged to release emanate hydrogen and oxygen that will form on demand.

9. Machine produce energy set forth claim 1, water gas machine it's a portable and easy to transport or mobile unit and is designed quick release dissemble or separate the unit and install same time by one carrier person.

10. Machine produce energy set forth claim 1, water gas machine require no compressed gas storage and maintained economically and can be kept indoor safely without concern of leakage of toxic gas or fire explosion. It's clean gas energy and free from pollution.

11. Machine produce energy set forth claim 1, the water gas machine split water into hydrogen and oxygen where is adapted in LC circuit method to propagate water molecules into high energy level that is employed through AC induction convert voltage ripple pulse and frequency from mode controller to the exciters chamber.

12. Machine produce energy set forth claim 1, water gas machine or apparatus provide build in switch with circuit breaker which set off safely if detected with faulty function or intermitted by electrical abnormally.

13. The machine produce energy set forth claim 1, water gas machine safety mechanism in case of back fire is to implode into back into water tank and release back pressure to ambient air safely by relieve valve or solenoid valve pressure sensor.

14. Machine produce energy set forth claim water 1, gas machine or apparatus that circulate water to electromagnetic connected pipe anti-corrosion employed for induction to the LC circuit pick up pulse to further propagate the gas flow exit port. While water induced by circulation electrical current and pulses flow to exciters chamber to bring batter equilibrium water state and release access heat for cooling.
